(19) United States
(12) Patent Application Publication
(10) Pub. No.: US 2019/0102158 A1
(43) Pub. Date: Apr. 4, 2019

(54) SYSTEM AND METHOD FOR PROVIDING SOFTWARE UPDATES IN ASSEMBLY LINE AND DEALERSHIP LOT ENVIRONMENTS

(71) Applicant: GM GLOBAL TECHNOLOGY OPERATIONS LLC, Detroit, MI (US)

(72) Inventors: Lakshmi V. THANAYANKIZIL, Rochester Hills, MI (US); John SERGAKIS, Bloomfield Hills, MI (US); Wen GU, Novi, MI (US); Michael C. HEITMANN, Shelby Township, MI (US)

(21) Appl. No.: 15/719,764

(22) Filed: Sep. 29, 2017

(51) Int. Cl. G06F 9/445; H04W 48/20

(52) U.S. Cl. CPC G06F 8/65; H04W 48/20

(57) ABSTRACT

In an example, an access point device for providing software updates to vehicles is disclosed. In an example implementation, the access point device includes a communication module that is configured to establish a wireless connection with respective control modules of the vehicles. The communication module is configured to receive vehicle identification information from the respective vehicles. The access point device also includes a vehicle update determination module that is configured to establish a connection with a server and determine whether a software update is available from the server for the vehicles based upon the vehicle identification information. The vehicle update determination module is configured to initiate a download of the software update from the server when the software update is available.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for updating vehicle systems, and more particularly to systems and methods for providing software updates over a wireless communication network to control modules of vehicles.

Vehicles, such as cars and trucks, typically include control modules that are programmed to control one or more vehicle systems. However, the control modules require software updates as additional vehicle features are provided and/or the software installed in the control modules requires updating.

### SUMMARY

In an example, an access point device for providing software updates to vehicles is disclosed. In an example implementation, the access point device includes a communication module that is configured to establish a wireless connection with respective control modules of the vehicles. The communication module is configured to receive vehicle identification information from the respective vehicles. The access point device also includes a vehicle update determination module that is configured to establish a connection with a server and determine whether a software update is available from the server for the vehicles based upon the vehicle identification information. The vehicle update determination module is configured to initiate a download of the software update from the server when the software update is available.

In other features, the access point device includes an update prioritization module that is configured to prioritize providing the software update to the vehicles based upon a vehicle parameter and a software update parameter. In other features, the vehicle parameter includes a vehicle power level or a shipping date of the vehicle. In other features, the update prioritization module is further configured to prioritize transmission of the software updates by comparing vehicle power levels of at least two of the vehicles. In other features, the update prioritization module is further configured to prioritize transmission of the software updates by comparing vehicle shipping dates of at least two of the vehicles. In other features, the update prioritization module is further configured to initiate transmission of the software update to at least one vehicle according to the prioritization.

In other features, the vehicles communicate with the communication module according to a Wi-Fi protected access communication protocol. In other features, the software update is stored in memory of the access point device. In other features, the vehicle update determination module is further configured to query the server at predetermined time intervals to determine whether the software update is available. In other features, the vehicle update determination module is configured to initiate transmission of the software update upon downloading the software update from the server.

In another example, a server providing software updates to at least one vehicle is disclosed. In an example implementation, the server includes a communication module that is configured to receive information from each access point device indicative of the vehicle connected to the corresponding access point device over a wireless network. The information includes a software version installed on a control module of the vehicle. The server also includes a vehicle update determination module that is configured to determine whether the vehicle requires a software update based upon the software version, and an access point device selection module that is configured to select at least one access point device to provide the software update to the control module based upon a vehicle power level, a vehicle shipping date, a software update parameter, and a network parameter.

In other features, the vehicle communicates with the access point devices according to a Wi-Fi protected access communication protocol. In other features, the access point device selection module is further configured to select an access point device based upon a comparison of the vehicle power level with a predetermined power level threshold. In other features, the access point device selection module is further configured to select an access point device by comparing the vehicle shipping date with a predetermined shipping date threshold. In other features, the software update includes a software criticality, and the access point device selection module is further configured to select an access point device by comparing the software criticality with a predetermined software update threshold.

In other features, the access point device selection module is further configured to select an access point device based upon a signal strength of the access point device or a congestion parameter of the access point device. In other features, the communication module transmits the software update to an access point device according to the selection. In other features, the access point device selection module causes an access point device to cause the at least one vehicle to communicate with another one of the plurality of access point devices. In other features, the access point device selection module is further configured to determine whether a single access point device is capable of providing the software update to the vehicles. In other features, the access point device selection module is further configured to select the single access point device upon determining that the single access point device is capable of providing the software update to the vehicles.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a block diagram illustrating an example wireless communication system for providing software updates to one or more vehicles in accordance with an example implementation of the present disclosure;

FIG. 1B is a schematic diagram illustrating the example wireless communication system for providing software updates to the one or more vehicles in accordance with an example implementation of the present disclosure;

FIG. 2 is a block diagram of an access point device in accordance with an example implementation of the present disclosure;

FIG. 3 is a block diagram of a server in accordance with an example implementation of the present disclosure;

FIGS. 4 through 7 are flow diagrams illustrating examples of methods in accordance with an example implementation of the present disclosure.

In the drawings, reference numbers may be reused to identify similar and/or identical elements.

### DETAILED DESCRIPTION

Managing the increasing number and complexity of control modules in a vehicle has become a challenge for vehicle manufacturers. For instance, software updates may be available after a vehicle leaves the assembly line but before the vehicle is delivered to an end user. However, while these vehicles are in a shipping lot, in a dealership lot, or other holding area, batteries in the vehicles are not charged or are infrequently charged. Thus, these vehicles have a limited power supply to query wireless communication networks to determine whether software updates are available and to obtain any available software updates

An access point device provides software updates to multiple vehicles. In an example implementation, the access point device includes a communication module that establishes a wireless connection with respective control modules of the vehicles. The communication module receives vehicle identification information corresponding to each vehicle. The access point device also includes a vehicle update determination module that establishes a connection with a server and determines whether a software update is available from the server for the plurality of vehicles based upon the vehicle identification information. The vehicle update determination module initiates a download of the software update from the server when the software update is available.

In another implementation, a system for providing software updates to vehicles is disclosed. The system includes a server that communicates with multiple of access point devices. The server includes a communication module that receives information from each access point device indicative of vehicle connected to the corresponding access point device over a wireless network. The information includes a software version installed on a control module of the vehicle. The server also includes a vehicle update determination module that determines whether the vehicle requires a software update based upon the software version. The server also includes an access point device selection module that determines an access point device to provide the software update to the control module based upon at least one of a vehicle parameter, a software update parameter, or a network parameter.

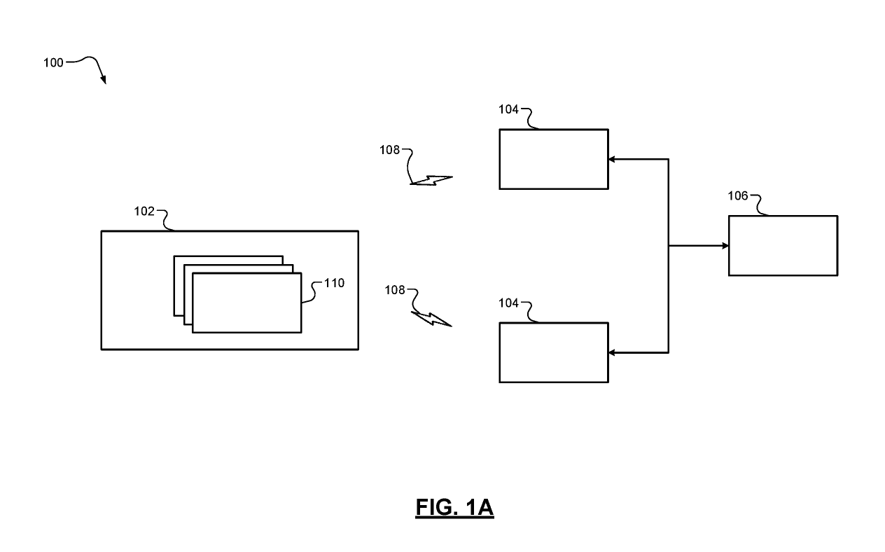

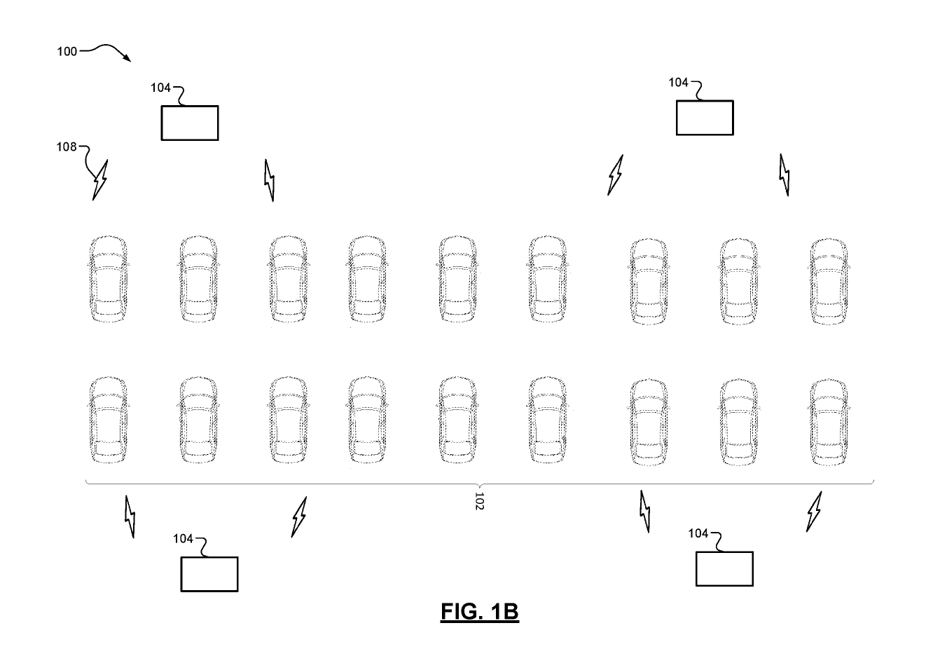

FIGS. 1A and 1B are example diagrams of a wireless communication system 100 for providing software updates to one or more vehicles 102. The wireless communication system 100 includes multiple access point devices 104 and one or more servers 106.

The servers 106 store the software updates that can be provided to the access point devices 104 upon request. The access point devices 104 provide the software updates to the vehicles 102 over a wireless network 108. FIG. 1B illustrates an example environment when multiple vehicles 102 are located. In one or more examples, the environment may be an automobile dealership environment, a manufacturing environment, a shipping lot environment, or the like. The access point devices 104 may be deployed throughout the environment. For example, the access point devices 104 can be organized to form a wireless mesh network. In some examples, the access point devices 104 can be located on any suitable structure, such as a lighting structure, or the like. In this environment, the wireless communication system 100 can be employed to provide software updates to vehicles 102 prior to a vehicle being sold or leased to an end user.

In one or more implementations, the wireless network 108 includes, but is not limited to networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Wi-Fi Protected Access (WPA); WPA Enterprise; Bluetooth standards promulgated by the Bluetooth Special Interest Group; and so on.

As shown in FIG. 1A, the vehicle 102 includes one or more control modules 110 that control one or more vehicle systems. In example implementations, the control module 110 can include any control module employed by the vehicle 102. For example, the control module 110 may control the steering system of the vehicle 102. In another example, the control module 110 may control the braking system of the vehicle 102. In yet another example, the control module 110 may control the power system of the vehicle 102.

The vehicles 102, through the control module 110, communicate with the access point devices 104 over the wireless network 108. For example, when the vehicle 102 is located within one of the environments described above, the control module 110 establishes communication with the access point device 104 over the wireless network 108. In one example, the control module 110 automatically establishes the communication channel with the access point device 104 having the greatest signal strength within the environment.

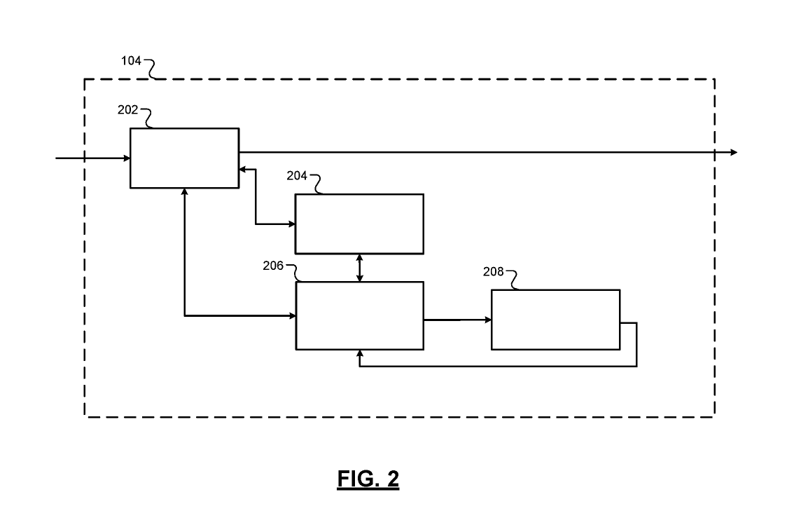

FIG. 2 illustrates an access point device 104 according to an example implementation of the present disclosure. In this implementation, the access point device 104 includes a communication module 202, a vehicle update determination module 204, a database 206, and an update prioritization module 208.

The communication module 202 receives a connection request from the control module 110 of the vehicle 102 to allow the access point device 104 and the control module 110 to communicate. Once the connection is established, the control module 110 transmits vehicle information for the vehicle 102 to the communication module 202. The vehicle information includes vehicle identification information, vehicle security credentials, software versions installed within the control module 110, and the like. After initial communication, the vehicle 102 may then enter a reduced power state (i.e., low power state) to reduce energy consumption.

In one implementation, the vehicle update determination module 204 queries the server 106 to determine whether software updates for the vehicle 102 are available. The query can include the vehicle information to allow the server 106 to cross-reference the vehicle information with software updates to determine whether software installed on the control module 110 requires a software update. If no software updates are available, the vehicle update determination module 204 queries the server 106 at predetermined time intervals to determine whether software updates are available.

When the vehicle 102 requires the software update, the server 106 provides the software update to the access point device 104. Software updates can then be stored within the access point device 104 (i.e., on memory resident within the access point device 104, etc.). Upon receiving the software update, the database 206 provides a software update signal to the communication module 202 to cause the communication module 202 to transmit the software update to the vehicle 102.

In another implementation, the vehicle update determination module 204 queries the server 106 for any software update at predetermined time intervals. The update prioritization module 208 prioritizes the software updates when multiple vehicles 102 are connected to the access point device 104. The update prioritization module 208 prioritizes providing the software updates to the vehicles 102 based upon one or more vehicle parameters, one or more software update parameters, and the like.

For example, the update prioritization module 208 prioritizes software updates based upon vehicle power level, vehicle shipping date, type of software update, or the like. The update prioritization module 208 provides a vehicle prioritization signal to the database 206, and the database 206 provides the software updates and associated vehicle information to the communication module 202. The communication module 202 transmits the software updates to corresponding vehicles 102 according to the vehicle prioritization signal.

For instance, the update prioritization module 208 compares the vehicle power levels of the respective vehicles requiring the software update with other vehicle power levels. The update prioritization module 208 can prioritize vehicles 102 having the lowest power level with respect to one another.

In another instance, the update prioritization module 208 compares the software update parameters of the vehicles 102 to a predetermined software update threshold. The update prioritization module 208 can prioritize vehicles 102 based upon deviation of the respective software update parameters with respect to the predetermined software update threshold (i.e., prioritize critical software updates, specific vehicle feature software updates, etc.).

In yet another instance, the update prioritization module 208 compares the shipping date of the vehicles 102 requiring the software update to other shipping dates. The update prioritization module 208 can prioritize vehicles 102 based upon the vehicle having the earliest shipping date with respect to one another.

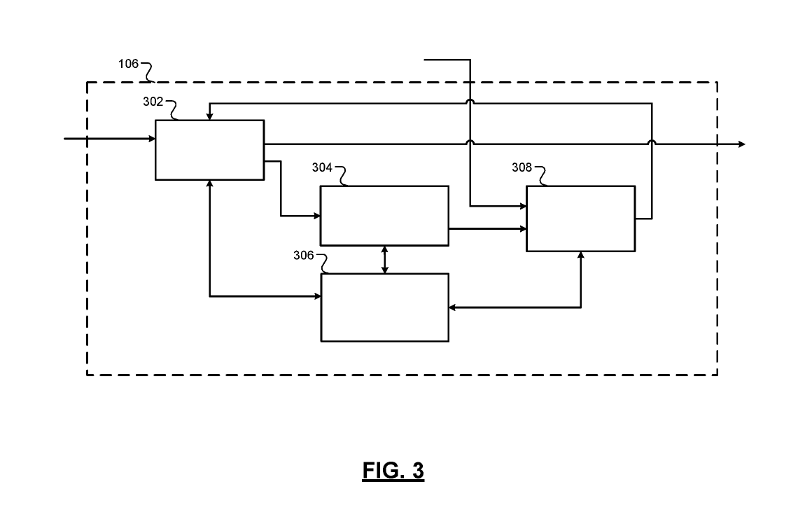

Referring to FIG. 3, an example server 106 in accordance with an example implementation of the present disclosure is illustrated. The server 106 includes a communication module 302, a vehicle update determination module 304, a database 306, and an access point device selection module 308.

The communication module 302 receives information from each access point device 104 indicative of the vehicles 102 that are in communication with the respective access point devices 104. The information can include a power level corresponding to vehicle 102, a software version installed on a control module 110 of the vehicle 102, vehicle identifier, and the like. For example, once a communication is established between the access point device 104 and the control module 110 of the vehicle, the control module 110 provides the information to the access point device 104. In another example, the control module 110 provides the information upon receiving a request from the access point device 104.

The update determination module 304 receives the information from the communication module 302. The update determination module 304 determines whether the vehicle(s) 102 requires software updates. For example, the update determination module 304 compares the provided software version with a software version stored in the database 306. The update determination module 304 can determine that the software update is required when the provided software version does not match the software version stored in the database 306. In another example, the update determination module 304 determines whether the vehicle 102 requires the software update based upon the vehicle identifier.

The access point device selection module 308 receives an input indicative of whether the vehicle 102 requires the software update from the update determination module 304. The access point device selection module 308 can also receive an input indicative of network parameters corresponding to the access point devices 104. The access point device selection module 308 selects an access point device 104 to provide the software update to the vehicles 102 based upon one or more vehicle parameters, one or more network parameters, one of more software update parameters, or the like.

The vehicle parameters can include vehicle power level, vehicle shipping date, vehicle distribution within the environment, and the like. The network parameters can include signal strength, communication channel security, channel congestion, and the like. The software update parameters can include type of software update to be downloaded (i.e., critical download, non-critical download, vehicle feature update, etc.). It is understood that the vehicle parameters, network parameters, and software update parameters may be provided by the respective vehicles 102, access point devices 104, and/or other client devices.

In one or more implementations, the access point device selection module 308 compares the vehicle, the network, and/or the software update parameters with predetermined parameters to select an access point device 104. In one implementation, the access point device selection module 308 selects the access point device 104 based upon (a) the vehicle power level; (b) the type of software update; (c) distribution of vehicles within the environment; and (d) vehicle shipping date.

For instance, the access point device selection module 308 compares the vehicle power level to a predetermined power level threshold. When the access point device selection module 308 determines the vehicle power level is below the predetermined power level threshold, the access point device selection module 308 selects an access point device 104 having a signal strength above a predetermined signal strength parameter and/or having a channel congestion parameter below a predetermined channel congestion parameter (i.e., a communication channel having less interference). In some examples, the access point device selection module 308 estimates the power level of the vehicle 102. The access point device selection module 308 can estimate the power level based upon when the vehicle 102 initially connected with an access point device 104.

In another instance, the access point device selection module 308 compares the software update parameter to a predetermined software update threshold. When the access point device selection module 308 determines the software update parameter is above the predetermined software update threshold (i.e., a critical software update, a vehicle feature update, etc.), the access point device selection module 308 selects an access point device 104 having a signal strength above a predetermined signal strength parameter, a channel congestion parameter below a predetermined channel congestion parameter, and/or a communication channel security (i.e., an encrypted communication channel, etc.) above a predetermined communication channel security parameter.

In another instance, the access point device selection module 308 selects an access point device 104 based upon the distribution of vehicles 102 within the environment. In an implementation, the access point device selection module 308 determines whether a single access point device 104 can provide software updates to multiple vehicles 102.

For example, the access point device selection module 308 determines whether the vehicles 102 are connected to different access point devices 104. If the vehicles 102 are connected to multiple access point devices 104, the access point device selection module 308 determines whether a single access point device 104 can provide the software update to each of the vehicles 102. For example, the access point device selection module 308 queries each of the access point devices 104 to determine whether an access point device 104 can communicate with the vehicles 102. If the access point device selection module 308 determines that a single access point device 104 can communicate with each of the identified vehicles 102, the access point device 104 is selected to provide the software updates. The access point device selection module 308 broadcasts a selection signal to the access point devices 104. The selection signal causes the non-selected access point devices 104 to communicate with the connected vehicles 102 to cause these vehicles 102 to establish communication with the selected access point device 104 (i.e., initiate a communication handover).

If the access point device selection module 308 does not identify a single access point device 104 that can provide the software update to each of the identified vehicles 102, the access point device selection module 308 can select a single access point device 104 that can provide the software update to largest subset of identified vehicles 102. After selecting the access point device 104 that connects with the largest subset of identified vehicles 102, the access point device selection module 308 selects the access point device 104 that can provide the software update to next largest subset of identified vehicles 102, and so on. The access point device selection module 308 then broadcasts the selection signal to cause the identified vehicles 102 to establish communication with the corresponding selected access point devices 104.

In yet another instance, the access point device selection module 308 compares the shipping date to a predetermined shipping threshold. When the access point device selection module 308 determines the shipping date is below the shipping date parameter (i.e., the vehicle 102 is shipping relatively soon), the access point device selection module 308 selects an access point device 104 having a signal strength above a predetermined signal strength parameter and/or a channel congestion parameter below a predetermined channel congestion parameter.

Once the access point devices 104 have been selected, the access point device selection module 308 provides a selected access point device signal to the database 306 to indicate the selected access point devices 104 and corresponding software updates. Upon receiving the selected access point device signal, the database 306 initiates transmission of the software updates via the communication module 302. For example, the communication module 302 provides the software updates to the selected access point devices 104 according to the selections.

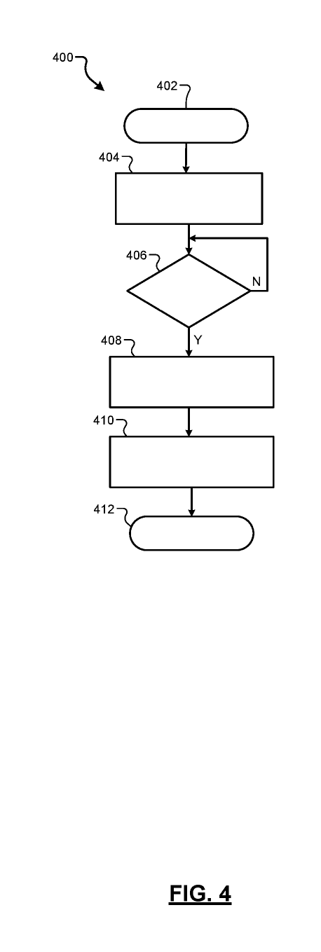

FIG. 4 illustrates a method 400 for determining software update availability for a vehicle 102 via an access point device 104 according to an example implementation of the present disclosure. The method 400 is described in the context of the modules included in the example implementation of the access point device 104 shown in FIG. 2. However, the particular modules that perform the steps of the method may be different than those mentioned below and/or the method may be implemented apart from the modules of FIG. 2.

The method starts at 402. At 404, the communication module 202 receives information from the vehicle 102. At 406, the vehicle update determination module 204 queries the server 106 to determine whether a software update is available for the vehicle based upon the information. If no software update is available, the method returns to 406. If the software update is available, the vehicle update determination module 204 obtains the software update from the server 106 at 408. At 410, the communication module 202 transmits the software update to the vehicle 102. The method ends at 412.

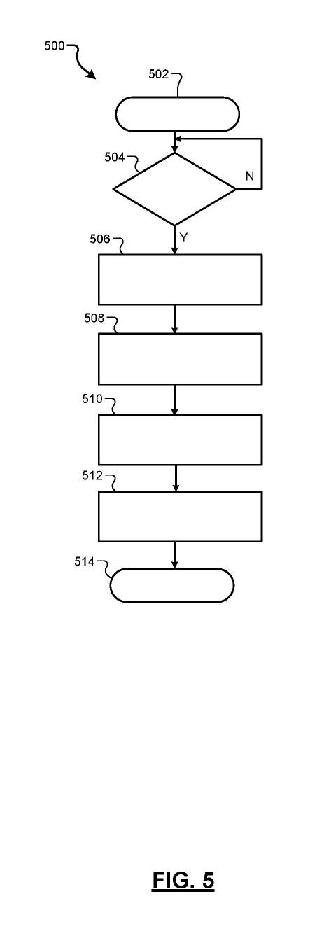

FIG. 5 illustrates a method 500 for prioritizing transmission of software updates to multiple vehicles 102 via an access point device 104 according to an example implementation of the present disclosure. The method 500 is described in the context of the modules included in the example implementation of the access point device 104 shown in FIG. 2. However, the particular modules that perform the steps of the method may be different than those mentioned below and/or the method may be implemented apart from the modules of FIG. 2.

The method starts at 502. At 504, the vehicle update determination module 204 queries the server 106 to determine whether any software update is available for any vehicle 102. If no software updates are available, the method returns to 504. If software updates are available, the vehicle update determination module 204 initiates download of the software updates from the server 106 at 506. At 508, information is received from vehicles 102. At 510, the update prioritization module 208 prioritizes transmission of the software updates to the vehicles 102 based upon the vehicle parameters, the network parameters, and/or the software update parameters. At 512, the update prioritization module 208 causes transmission of the software updates according to the determined prioritization. The method ends at 514.

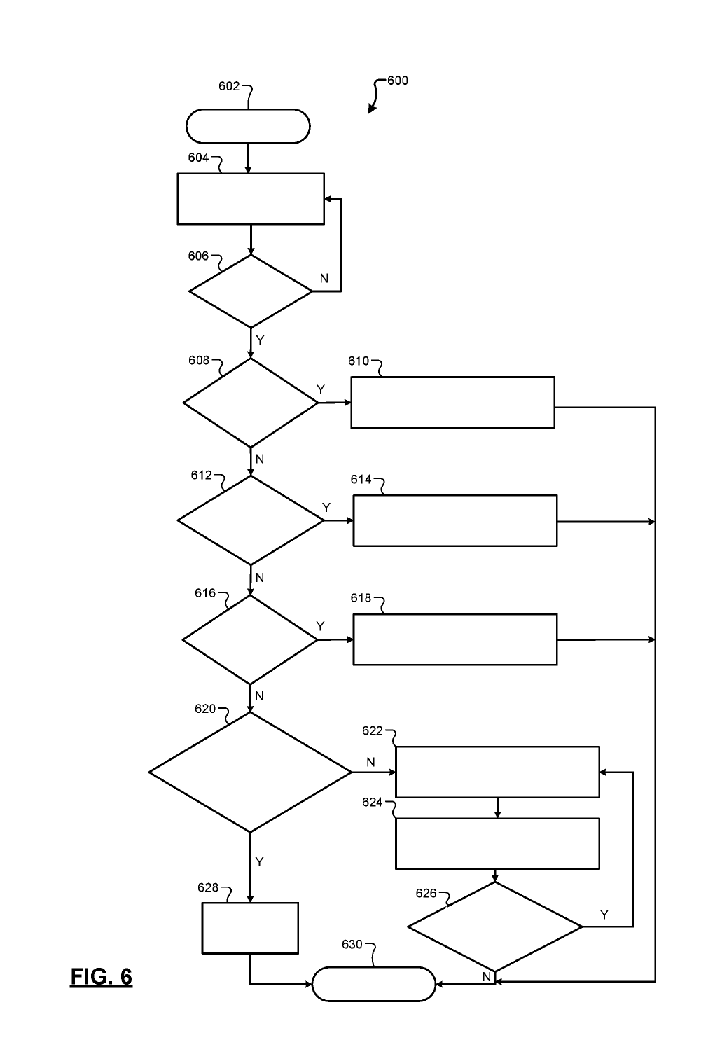

FIG. 6 illustrates a method 600 for selecting an access point device 104 via the server 106 according to an example implementation of the present disclosure. The method 600 is described in the context of the modules included in the example implementation of the server 106 shown in FIG. 3. However, the particular modules that perform the steps of the method may be different than those mentioned below and/or the method may be implemented apart from the modules of FIG. 3.

The method 600 begins at 602. At 604, the communications module 302 receives vehicle information from the access point devices 104. The information includes identification of the vehicles 102 that are connected to the respective access point devices 104 and the vehicles 102 that are within communication range of other the access point devices 104. At 606, the update determination module 304 determines whether one or more vehicles 102 require software updates based upon the software version of the respective vehicles 102. The method returns to 604 if the software update is not required.

At 608, the access point device selection module 308 determines whether the vehicle power level is below the vehicle power parameter. If the access point device selection module 308 determines the vehicle power level parameter is below the predetermined vehicle power threshold, the access point device selection module 308 selects an access point device 104 based upon the vehicle power level at 610. If the access point device selection module 308 determines the vehicle power level is not below the predetermined vehicle power threshold, the access point device selection module 308 determines whether the software update parameter is greater than the predetermined software update threshold at 612.

If the access point device selection module 308 determines the software update parameter is greater the predetermined software update threshold, the access point device selection module 308 selects an access point device 104 based upon the software update parameter at 614. If the access point device selection module 308 determines the software update parameter is not greater than the predetermined software update threshold, the access point device selection module 308 determines whether the shipping date parameter is greater than the predetermined software update threshold at 616.

If the access point device selection module 308 determines the shipping date parameter is less than the predetermined software update threshold, the access point device selection module 308 selects an access point device 104 based upon the shipping date parameter at 618. If the access point device selection module 308 determines the software update parameter is not less than the predetermined software update threshold, the access point device selection module 308 determines whether a single access point device can provide the software update to each vehicle within the environment at 430.

If the access point device selection module 308 determines that the single access point device 104 cannot provide the software update to each vehicle within the environment, the access point device selection module 308 determines an access point device 104 that can provide the software update to the greatest subset of vehicles 102 within the environment at 622. The identified access point device 104 is selected at 624. At 626, the access point device selection module 308 determines whether additional vehicles require the software update (i.e., vehicles 102 not in range of the selected access point device 104). If there are additional vehicles 102, the method returns to 622 to identify an access point device 104 for the addition vehicles. If the access point device can provide software updates to all the vehicles 102 located within the environment, the access point device is selected at 628. The method ends at 630.

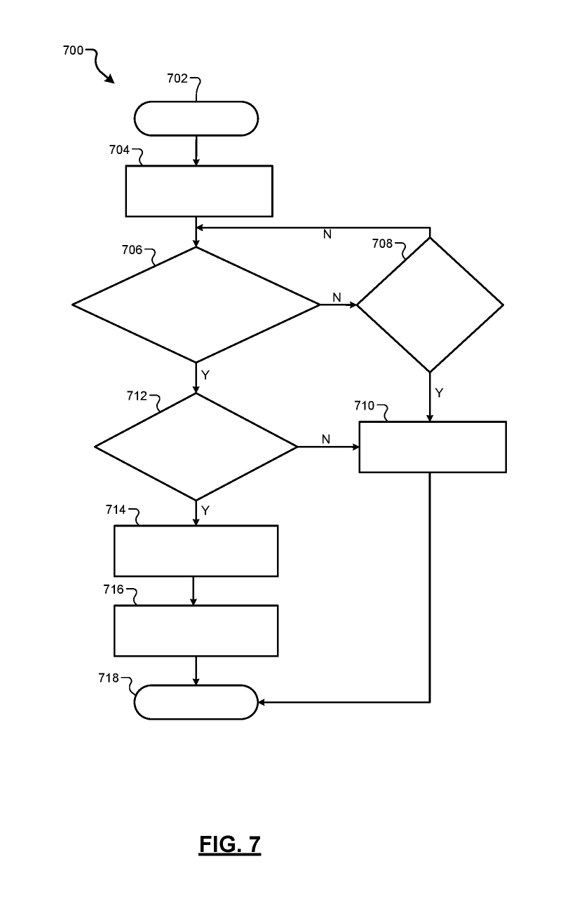

FIG. 7 illustrates an example method 700 for determining whether multiple access point devices can provide software updates. The method 700 is described in the context of the modules included in the example implementation of the server 106 shown in FIG. 3. However, the particular modules that perform the steps of the method may be different than those mentioned below and/or the method may be implemented apart from the modules of FIG. 3.

The method starts at 702. At 704, the communication module 202 receives vehicle information from an access point device 104. The information includes identification of the vehicles 102 that are connected to the respective access point devices 104 and the vehicles 102 that are within communication range of other the access point devices 104. At 706, the update determination module 204 determines whether multiple vehicles 102 require software updates based upon the software version of the respective vehicles 102. If multiple vehicles 102 do not require software updates, the access point device selection module 308 whether a single vehicle 102 connected to the access point device 104 requires the software update at 708.

If the access point device selection module 308 determines the single vehicle 102 requires the software update, the access point device 104 connected with the single vehicle 102 is selected to provide the software update at 710. If the access point device selection module 308 determines that no vehicles 102 require the software update, the method returns to 706.

If multiple vehicles 102 require software updates, the access point device selection module 308 determines whether another access point device 104 not connected to the vehicles 102 can provide the software update to one or more of the vehicles 102 at 712. If the access point device selection module 308 determines that no other access point devices 104 can provide the software updates, the access point device 104 currently connected with the multiple vehicles 102 is selected to provide the software update at 710.

If the access point device selection module 308 determines that other access point devices 104 can provide the software updates, the access point device selection module 308 selects one or more access point devices 104 based upon vehicle parameters, software update parameters, and/or shipping date parameters at 714. At 716, the access point device selection module 308 causes one or more vehicles 102 to establish a connection with the selected access point devices 104. The method ends at 718.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

1. An access point device located proximate to at least one of a dealership lot, a manufacturing facility, and a shipping lot for providing software updates to a plurality of vehicles, comprising:
a communication module that is configured to establish a wireless connection with respective control modules of the plurality of vehicles within at least one of the dealership lot, the manufacturing facility, and the shipping lot,
wherein the communication module is configured to receive vehicle identification information from the respective plurality of vehicles; and
a vehicle update determination module that is configured to establish a connection with a server that is distinct from the access point device and determine whether a software update is available from the server for the plurality of vehicles based upon the vehicle identification information,
wherein the vehicle update determination module is configured to initiate a download of the software update from the server when the software update is available;
an update prioritization module that is configured to prioritize providing the software update to the plurality of vehicles based upon a vehicle parameter and a software update parameter,
wherein the update prioritization module is further configured to prioritize transmission of the software updates by comparing vehicle power levels of at least two of the plurality of vehicles and prioritizing providing the software update to a first vehicle based upon a power level of the first vehicle relative to a power level of a second vehicle,
wherein the update prioritization module is further configured to initiate transmission of the software update to at least one vehicle of the plurality of vehicles within at least one of the dealership lot, the manufacturing facility, and the shipping lot according to the prioritization.

2. (canceled)

3. The access point device as recited in claim 1, wherein the vehicle parameter includes at least one of a vehicle power level and a shipping date of a vehicle of the plurality of vehicles.

4. (canceled)

5. The access point device as recited in claim 3, wherein the update prioritization module is further configured to prioritize transmission of the software updates by comparing vehicle shipping dates of at least two of the plurality of vehicles.

6. (canceled)

7. The access point device as recited in claim 1, wherein the plurality of vehicles communicate with the communication module according to a Wi-Fi protected access communication protocol.

8. The access point device as recited in claim 1, wherein the software update is stored in memory of the access point device.

9. The access point device as recited in claim 1, wherein the vehicle update determination module is further configured to query the server at predetermined time intervals to determine whether the software update is available.

10. The access point device as recited in claim 1, wherein the vehicle update determination module is configured to initiate transmission of the software update upon downloading the software update from the server.

11. A server for providing software updates to at least one vehicle, comprising:
a communication module that is configured to receive information from each access point device of a plurality of access point devices indicative of the at least one vehicle connected to the corresponding access point device over a wireless network, the information including a software version installed on a control module of the at least one vehicle;
a vehicle update determination module that is configured to determine whether the at least one vehicle requires a software update based upon the software version; and
an access point device selection module that is configured to select at least one access point device of the plurality of access point devices to provide the software update to the control module based upon a vehicle power level, a vehicle shipping date, a software update parameter, and a network parameter.

12. The server as recited in claim 11, wherein the at least one vehicle communicates with the plurality of access point devices according to a Wi-Fi protected access communication protocol.

13. The server as recited in claim 11, wherein the access point device selection module is further configured to select the at least one access point device based upon a comparison of the vehicle power level with a predetermined power level threshold.

14. The server as recited in claim 11, wherein the access point device selection module is further configured to select the at least one access point device by comparing the vehicle shipping date with a predetermined shipping date threshold.

15. The server as recited in claim 11, wherein the software update comprises a software criticality, wherein the access point device selection module is further configured to select the at least one access point device by comparing the software criticality with a predetermined software update threshold.

16. The server as recited in claim 11, wherein the access point device selection module is further configured to select the at least one access point device based upon at least one of a signal strength of the at least one access point device and a congestion parameter of the at least one access point device.

17. The server as recited in claim 11, wherein the communication module transmits the software update to at least one access point device of the plurality of access point devices according to the selection.

18. The server as recited in claim 11, wherein the access point device selection module causes at least one access point device to cause the at least one vehicle to communicate with another one of the plurality of access point devices.

19. The server as recited in claim 11, wherein the access point device selection module is further configured to determine whether a single access point device of the plurality of access point devices is capable of providing the software update to a plurality of vehicles.

20. The server as recited in claim 19, wherein the access point device selection module is further configured to select the single access point device upon determining that the single access point device is capable of providing the software update to the plurality of vehicles.
